(19) United States
(12) Patent Application Publication
(10) Pub. No.: US 2008/0196614 A1
(43) Pub. Date: Aug. 21, 2008

(54) CLAMPING AND RELEASING FLEXIBLE PLATES TO AND FROM AN IMAGING CYLINDER

(76) Inventors: Jorg Koberg, Hzehee (DE); Jurgen Andresen, Oldendorf (DE)

Correspondence Address: DOV ROSENFELD, 5507 COLLEGE AVE, SUITE 2, OAKLAND, CA, 94618, US

(21) Appl. No.: 12/021,635

(22) Filed: Jan. 29, 2008

Related U.S. Application Data
(60) Provisional application No. 60/890,698, filed on Feb. 20, 2007.

(51) Int. Cl. B41F 1/28

(52) U.S. Cl. 101/415.1; 101/485

(57) ABSTRACT

A method for fastening plates onto an imaging cylinder, and an apparatus that includes one or more clamping devices. Each clamping device includes a clamping bar and an air hose that when inflalted lifts the clamping bar so that one end of a plate can be placed between the surface of the clyinder. The imaging clyinder includes magnetized elements on or close to the surface. A metal bar is placed on the plate near the magnetized element to hold the plate that is already clamped at one end. The apparatus is operative to fasten flexible plates, metal back plates and non metal back plates onto an imaging cylinder. Embodiments of the apparatus can work with plates of different material, thickness and format onto an image cylinder.

### RELATED APPLICATION(S)

The present invention claims priority of and is a conversion of U.S. Provisional Patent Application 60/890,698 filed 20 Feb. 2007 to inventors Koberg et al., and titled CLAMPING AND RELEASING FLEXIBLE PLATES TO AND FROM AN IMAGING CYLINDER. The contents of such U.S. Application 60/890,698 are incorporated herein be reference.

### FIELD OF THE INVENTION

The present disclosure relates generally to imaging to produce printing plates, and in particular to a clamping and releasing method, and an apparatus to clamp and release flexible printing plates of different formats and thicknesses.

### BACKGROUND

Flexographic plates are frequently exposed from computer data using computer-to-plate (CTP, C2P) imaging. Mounting such plates on a cylinder, e.g., the cylinder or imaging cylinder of an external imaging cylinder imaging device is recognized as a problem. For example, one method to mount a flexographic plate on a cylinder is to fix the plates with adhesive tape at the edges. More modern methods use a clamping bar, which clamps the top and bottom edge of a full-size flexographic plate onto the cylinder. The first adhesive tape method is very time consuming and the second method using a clamping bar only works with full format plates. Since flexographic plate material is relatively expensive a modern method to mount partial plates on a full format cylinder are becoming more and more important.

An example of an external imaging cylinder imaging device for which such a method and apparatus is applicable is the Esko-Graphics Cyrel Digital Imager (CDI) made by Esko-Graphics A/S, Ballerup, Denmark, the assignee of the present invention.

U.S. Pat. No. 7,165,492 to Koberg, et al. titled METHOD AND APPARATUS TO CLAMP AND RELEASE FLEXIBLE PLATES ON TO AN IMAGING CYLINDER (issued on Jan. 23, 2007) describes a clamping device, a cylinder including a clamping device, and a method for clamping a plate onto the outer surface of the cylinder. The clamping device includes a base body extending in the axial direction and fixed to, or incorporated into the cylinder. The clamping device also includes a clamping element extending in the axial direction. The clamping device also includes a lifting element located in the interior of the base body and coupled to the clamping element by at least one guiding shaft. The lifting element is movable in a first radial direction to move the clamping element away from the outer surface of the cylinder to form a gap between the outer surface and the clamping element. The lifting element also is movable in the radial direction opposite the first radial direction to close the gap formed between the outer surface of the cylinder and the clamping element. The clamping device also includes a mechanism to impart and maintain compressive force between the clamping element and the outer surface of the cylinder such that any gap formed is maintained closed unless forcibly opened. The apparatus is arranged such that when the gap is formed by moving the lifting element in the first radial direction, the edge of a flexible plate can be placed in the gap, and such that when the gap is closed, the plate is maintained clamped onto the outer edge of the cylinder.

In this description and in the claims, by a full-format plate is meant a plate that covers the whole imaging area of the cylinder. By a partial-format plate is meant a plate that covers part of the overall imaging area, such that several partial-format plates (also called plate segments) may be combined to cover the whole imaging area.

One prior art method is for a machine operator to manually mount a full-format plate or partial-format plates onto a cylinder with adhesive tape. Such a method is used, for example, by external imaging cylinder imaging machines such as the ThermoFlex™ product line made by CREO Inc. of Burnaby, BC, Canada. However, to mount full-format or partial-format plates with adhesive tape is highly time consuming, the operator first mounts a first edge of the plate on the cylinder, fixes it with adhesive tape, turns the cylinder around so that the plate covers the cylinder, and then tapes all the rest of the edges of the plate.

Another prior art solution is for the machine operator to mount full-format plates—those that fully cover the circumference of a cylinder—with the use of a clamp, which is activated manually. An example of a device for so mounting full-format plates is a device used with an imaging cylinder, called EasyClamp™, made by Esko-Graphics A/S, Ballerup, Denmark, the assignee of the present invention. If partial-format plates are used, the machine operator first mounts partial-format plates onto the cylinder with the use of adhesive tape. The mounting by use of adhesive tape, as stated above, is time consuming.

Yet another prior art solution is for the machine operator to mount full-format plates—the case of the circumference of the cylinder being fully covered by the plate—using a terminal strip, which is activated manually. For mounting a plate, the terminal strip has to be opened manually, the plate has to be fixed under the terminal strip, the terminal strip has to be closed manually, the cylinder then has to be turned around, the terminal strip has to be opened manually again, the second plate edge has to be positioned under the terminal strip and then the terminal strip has to be closed manually. In all cases with the use of a terminal strip, the activation is done by manually by turning a key. This method is suggested, for example, in the HelioFlex® range of products made by HELL Gravure Systems GmbH of Kiel, Germany.

Note that as is the case with the Esko-Graphics EasyClamp™, the terminal strip is only for full-format plates. The machine operator mounts partial-format plates with the use of adhesive tape. The mounting by use of adhesive tape, as stated above, is time consuming.

There thus is a need in the art for a method and apparatus that avoids the manual steps of opening and closing clamping devices or a terminal strip, and for an apparatus therefore.

There also is a need in the art to automatically clamp a flexible plate onto an imaging cylinder.

There have been previous attempts at automating plate clamping. For example, U.S. Pat. No. 6,561,094 titled “DEVICE FOR FIXING A FLEXIBLE PLATE ON A IMAGING CYLINDER” and U.S. Pat. No. 6,598,530 titled “METHOD FOR FASTENING A FLEXIBLE PLATE,” both assigned to Koenig & Bauer AG, of Würzburg, Germany, describe some such other attempts. These are referred to herein as the Koenig & Bauer methods and mechanisms, as the case might be.

The Koenig & Bauer clamping mechanisms are relatively complicated and more expensive. Therefore there is still a need in the art for new clamping methods, e.g., that are simpler and less expensive than the Koenig & Bauer methods and mechanisms.

The Koenig & Bauer methods are applicable to flexible plates that have bent suspension legs. Typical flexographic plates need to be clamped at the end edges, and such do not typically have bent suspension edges. Therefore there still is a need in the art for clamping both full-format and partial-format flexible plates at the end edges, such plates not having bent suspension edges.

The patents describe the use of automatic loading in imaging cylinders; the present invention relates to loading onto an imaging cylinder for CTP systems.

The Koenig & Bauer methods and apparatuses limit the number of clamps on the peripheral cylinder surface to two. Therefore there still is a need in the art for a clamping method and clamping apparatuses such that the number of clamping devices on a cylinder is not limited to a relatively small number.

### SUMMARY

Embodiments of the present invention include a method for fastening plates onto an imaging cylinder, and an apparatus that includes one or more clamping devices. The apparatus is operative to fasten flexible plates, metal back plates and non metal back plates onto an imaging cylinder. Embodiments of the apparatus can work with plates of different material, thickness and format onto an image cylinder.

One embodiment includes an apparatus that includes an imaging cylinder of an imaging device, the cylinder having an outer surface and an inner wall; a clamping device arranged for clamping one edge of a flexible plate onto the outer surface of the cylinder; and at least one magnetized element close to or on the surface of the cylinder, such that a metal bar made of a material attracted to the magnetized element placed on a plate clamped at the one edge and close to a magnetized element maintains a force on the plate towards the surface of the cylinder. The clamping device includes: a base body having a hollow interior, and extending in the axial direction of the cylinder, the base body being fixed to the inner wall of the cylinder or incorporated into the inner wall of the cylinder; a clamping element having a width and extending in the axial direction of the cylinder, located adjacent to the outer surface of the cylinder wherein the base body is located; a lifting element located in the interior of the base body and coupled to the clamping element by at least one guiding shaft, the lifting element being movable in a first radial direction to move the clamping element away from the outer surface of the cylinder to form a gap between the outer surface and the clamping element, the lifting element further being movable in the radial direction opposite the first radial direction to close the gap formed between the outer surface 111 of the cylinder and the clamping element; and a mechanism to impart and maintain compressive force between the clamping element and the outer surface 111 of the cylinder such that any gap formed is maintained closed unless forcibly opened. The width of the clamping element is configured such that a gap formed between the clamping element and the outer surface is sufficient to grip the edge of a plate when the gap is closed. The apparatus is arranged such that when the gap is formed by moving the lifting element in the first radial direction, the edge of a flexible plate can be placed in the gap, and such that when the gap is closed, the plate is maintained clamped onto the outer edge of the cylinder.

Particular embodiments may provide all, some, or none of these aspects, features, or advantages. Particular embodiments may provide one or more other aspects, features, or advantages, one or more of which may be readily apparent to a person skilled in the art from the figures, descriptions, and claims herein.

### BRIEF DESCRIPTION OF THE DRAWINGS

FIG. 1A shows a cross-sectional view of an imaging cylinder with a single magnetized element according to an embodiment of the present invention.

FIG. 1B shows a representation of an air pressure supply coupled to work with the clamping device embodiment shown in FIG. 1A.

FIG. 1C shows in simplified form an embodiment with an automatic loader/unloader and a control system.

FIG. 2 shows a cross-sectional view of an imaging cylinder with a single adjustable magnetized element according to an embodiment of the present invention.

FIG. 3 shows a cross-sectional view of an imaging cylinder with two magnetized elements according to an embodiment of the present invention.

FIG. 4A shows a cross-sectional view of an imaging cylinder with magnetized elements according to an embodiment of the present invention.

FIG. 4B shows a view of a core layer inside the three-ply wall of an imaging cylinder with magnetized elements according to an embodiment of the present invention.

FIG. 5 shows a perspective view of an imaging cylinder that includes a magnet segment, shown with a metal bar and a plate according to an embodiment of the present invention.

FIG. 6 shows a perspective view of a cutout that includes an embodiment of the present invention.

FIG. 7 is a representation of a first stage of an automated imaging cylinder loading process according to an embodiment of the present invention.

FIG. 8 is a representation of a second stage of an automated imaging cylinder loading process according to an embodiment of the present invention.

FIG. 9 is a representation of a third stage of an automated imaging cylinder loading process according to an embodiment of the present invention.

FIG. 10 is a representation of a fourth stage of an automated imaging cylinder loading process according to an embodiment of the present invention.

FIG. 11A shows a section of an imaging cylinder with a plurality of clamping elements along the axial direction according to a first embodiment.

FIG. 11B shows a section of an imaging cylinder with a plurality of clamping elements along the axial direction according to a second embodiment.

FIG. 12 shows a cross-sectional view of an imaging cylinder with a plurality of clamping devices along the circumferential direction according to an embodiment of the present invention.

### DESCRIPTION OF EXAMPLE EMBODIMENTS

One embodiment of present invention is a method for fastening flexible plates, metal back plates and non metal back plates onto an imaging cylinder. Another embodiment is an apparatus operable method to fasten flexible plates, metal back plates and non metal back plates onto an imaging cylinder. Such plates include digital flexographic plates, elastomere (rubber) plates, metal back plates or conventional flexographic plates. Embodiments of the invention provide a relatively easy method to clamp and release such plates automatically onto an imaging cylinder independent from plate type, thickness and format.

One method of the invention includes integrating a mechanism into an imaging cylinder to clamp and release plates. The mechanism includes a clamping device for clamping one end of an imaging plate, and one or more magnetized elements in the imaging cylinder to aid holding the other end of the plate onto the surface of the imaging cylinder. The combination is designed such that it can easily be automated.

One embodiment is an imaging cylinder with the clamping mechanism that includes the clamping device and the one or more magnetized elements.

The same clamping mechanism can work for different plate types, plate formats and plate thicknesses.

Embodiments of the present invention use a clamping device that can be activated by applying air pressure from a pump or external connection. Such a clamping device is described, for example, in U.S. Pat. No. 7,165,492, the contents of which are incorporated by reference. By using such a clamping device to clamp one end of a plate, the operator only has to press a button or a foot panel to open or close the clamping device.

For some plates that are shorter than the whole circumference of the imaging cylinder, an additional element used is a bar made of steel or similar material that is attracted by a magnet. Using such a bar in combination with the one or more magnetized elements in the imaging cylinder, or a magnetized inner core in the imaging cylinder allows the second end of a plate to be fixed onto the surface of the imaging cylinder without the need for adhesive tape.

Such a metal bar may not be needed for metal backed plates.

Thus partial and full format plates are directly clamped at the end edges by the clamping devices.

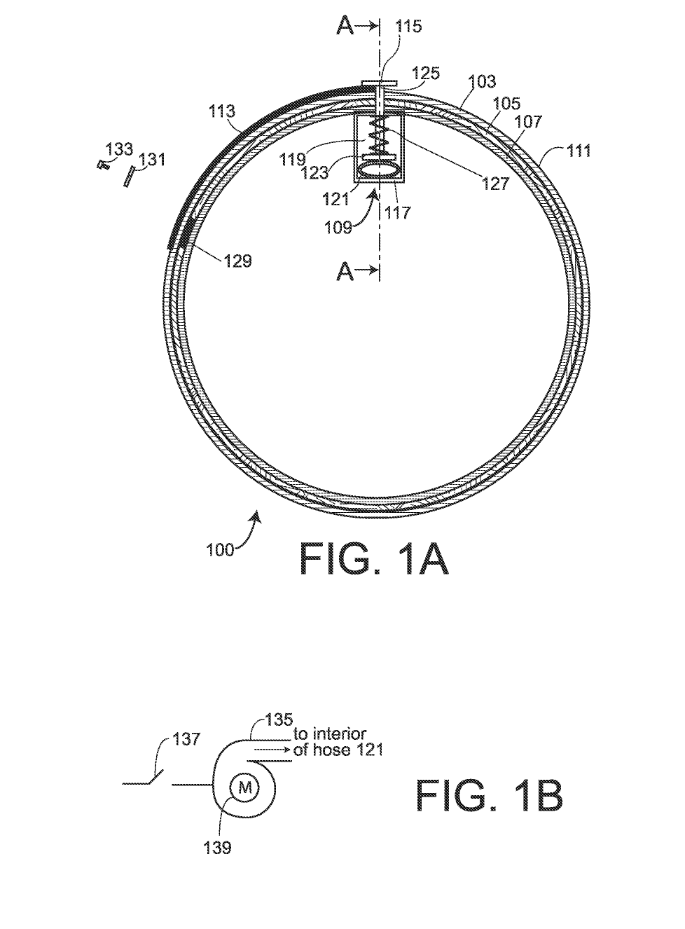

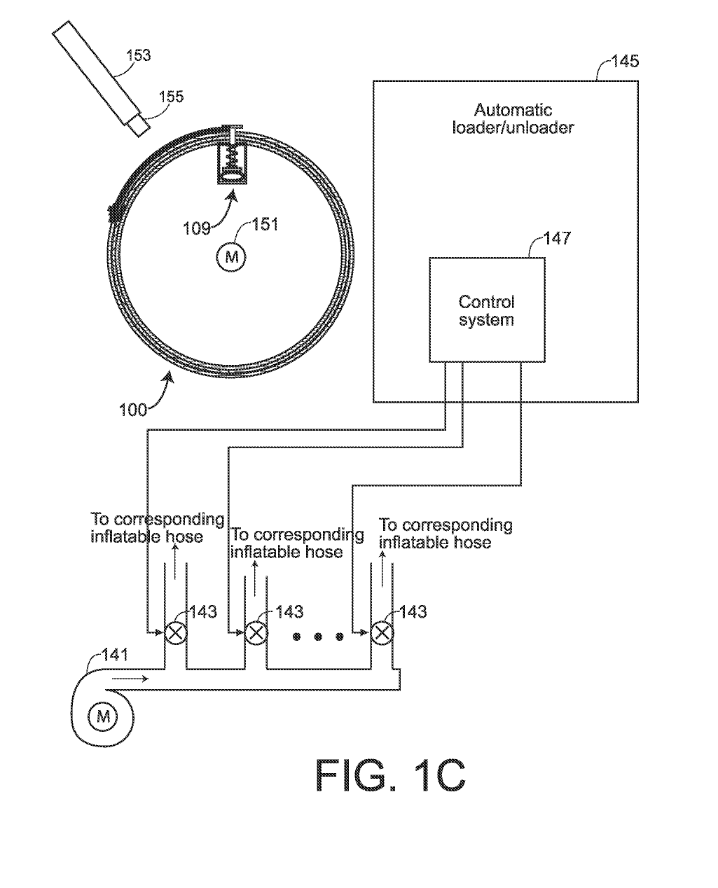

FIG. 1A shows a cross section of a cylinder 100 that has an outer surface 111 and that in one embodiment is made of an outer layer 103, an inner layer 107 and a middle layer or core 105. The cylinder includes a clamping device 109 used in an embodiment of the present invention. The cylinder 100 is, for example, the cylinder of an external imaging cylinder imaging device for imaging flexible plates such as flexographic plates or flexographic plate segments. The cylinder's clamping device 109 is shown in the plate holding (“closed”) position, with the end of one plate 113 clamped onto the outer surface 111 of the cylinder 100.

The clamping device 109 includes a clamping element 115 that has a width and that extends in the axial direction of the cylinder, i.e., in the direction perpendicular to the plane of the drawing. The clamping element 115 and its width are configured to receive a flexible plate in the gap formed between the clamping element and the outer surface 111 of the cylinder 100, one such plate 113 is shown in FIG. 1A located on the circumferential surface 111 of the cylinder 100. The clamping device 109 includes a base body 117 that has a hollow interior 119, which in one embodiment has an approximately rectangular cross-section, and in another, an elliptical or circular cross-section. The base body 117 extends in the axial direction, and in one embodiment is fixed to the inner wall of the inner layer 107 of the cylinder 100, and in another embodiment, is incorporated with the inner wall of the inner layer 107 of the cylinder 100.

An inflatable air hose 121 made of an inflatable material—a rubber compound in one embodiment—is mounted in the hollow interior 119 of the base body 117. The air hose 121 has an inflated state and an uninflated state. A lifting element 123 is mechanically coupled to the clamping element 115, in one embodiment using at least one guiding shaft 125. At least one spring 127 is positioned between the lifting element 123 and the base body 117 and biased to exert a force onto the lifting element 123 to compress the inflatable air hose 121 when the hose 121 is not inflated. In one embodiment, there is one spring per guiding shaft.

FIG. 1B shows a source of air pressure, e.g., a pump 135 that is coupled to the interior of the inflatable air hose 121 and configured to provide air pressure to the interior of the inflatable air hose 121 to inflate the hose 121. In one embodiment, the pump includes a motor 139 and is electrically activated by an electric switch 137 that can be operated, e.g., by the operator pushing a button or activating the pump by a foot panel.

In an alternate embodiment, a valve element 143 (see FIG. 1C), such as an air pressure switching device, e.g., a magnetic valve is included, and used by an operator or by a control system to automatically switch air pressure on or off while the pump is in operation. In yet another alternate embodiment, an external source of compressed air is used, and a switching device, such as a magnetic valve, is used for switching the air pressure on or off.

While the embodiment described herein is for manual operation under control of an operator, those in the art will easily recognize that the method and apparatus is readily adaptable for automatic operation under control of a control system that automatically switches the air supply on or off, as required, at the correct moments. Such an embodiment is shown in simplified form in FIG. 1C where an automatic loader/unloader 145 is shown with an imaging cylinder 100 of an external imaging cylinder imager. Other components of the imager are not shown, as would be clear to those in the art. The method and apparatus described herein is readily adaptable to work in conjunction with an automatic loading device such as loader/unloader 145. At least one instance of the clamping device 109 is included on the imaging cylinder 100. Each instance includes a corresponding inflatable hose. A pump 141 is included and is on during operation. The pump is coupled via at least one individual valve device 143 to a corresponding instance of a clamping device. In one embodiment, each valve element is a magnetic valve. While in one embodiment, an operator switches the supply on or off to the corresponding clamping device's inflatable air hose to selectively provide an air supply to any selected clamping device or devices, in the example shown in FIG. 1C, a control system 147 is included to automatically switch the air supply according to the sequence of loading or unloading of the automatic loader/unloader. One example of a control system 147 is a programmable microcontroller programmed to control the sequence of operation of the automatic loader/unloader 145 and of the at least one switching device 143 and corresponding clamping device.

One embodiment includes a handling unit that is coupled to the control system 147 and that is operative, under control of the control system, to selectively hold and feed the metal bar 131 (FIG. 1A) onto the imaging clylinder 100. In one embodimnet, the handling unit includes a body 153 and a telescopic arm 155. One embodiment includes a motor 151 coupled to the control system 147 and operative to rotate the imaging cylinder. In one embodiment, under guidance of the control system, the motor 151 rotates the imaging cylinder so that the handling unit 153, 155 is aligned with the magnetized element 129.

Referring again to FIG. 1B, in an alternate embodiment, a control system of an automatic loader/unloader (not shown in FIG. 1B) is coupled to the switch controlling the pump, such that the air supply is switched on or off automatically according to the loading/unloading sequence.

Therefore, whenever the description herein describes the operator switching on or off the air supply, those in the art will recognize that in an automated system, the operator is readily replaced by a control system, e.g., a programmed microcontroller, to switch the air supply on or off, as required, e.g., by an automatic loading system coupled to or also controlled by the control system, such a controlling system controlling the pump switch in one version, and a pressure switching element such as a magnetic valve in another embodiment.

Continuing with the operator-assisted operation, and referring still to FIG. 1B, to load (or unload) a plate, the operator causes the source 135 of air pressure to provide air pressure to the interior of the inflatable air hose 121 to inflate the hose 121. So inflating the inflatable air hose 121 causes the cross section of the hose to expand. The air hose expanding imparts a force onto the lifting element 123 that causes the at least one spring 127 to compress the guide shaft and this causes the clamping bar to move such that a gap is created between the clamping element 115 and the outer surface 111 of the cylinder 100. Such a gap provides for inserting or removing the edge of a flexible plate between the clamping element 115 and the outer surface 111 of the cylinder 100. This state of the clamping device 109 is called the open state, and also the release state herein.

FIG. 1A shows one end of the plate 113 clamped onto the surface 111 of the clylinder 100. The one edge of the plate 113 is clamped with the force of the one or more springs 127.

In an alternate embodiment, the clamping element 115 is fragmented into a plurality of clamping segments in the axial direction to support clamping of more than one plate distributed in the axial direction.

The clamping device 109 can clamp flexible plates with various thicknesses onto the surface 111 of the imaging cylinder 100.

In one embodiment, the imaging cylinder includes one or more magnetized elements 129 made of a magnetized material close to or on the surface 111 of the cylinder. To fix a plate 113 that has a length which does not cover the whole circumference of the cylinder surface 111, that is, a length less than the circumference of the surface 111 of the imaging cylinder 100, a metal bar 131—e.g., in the shape of a metal ruler, and made of a material which is attracted to the magnetized material, e.g., steel—is placed over the plate near the end of the plate. The magnetic attraction between the metal bar 131 and the magnetized element 129 imparts a force on the plate towards the surface, and maintains the plate on the surface of the imaging cylinder.

In one embodiment, the magnetized element 129 is placed along the whole width of the imaging cylinder layers 103,105 and 107. The plate is thus fixed between the surface of the imaging cylinder 100 and the metal bar 131.

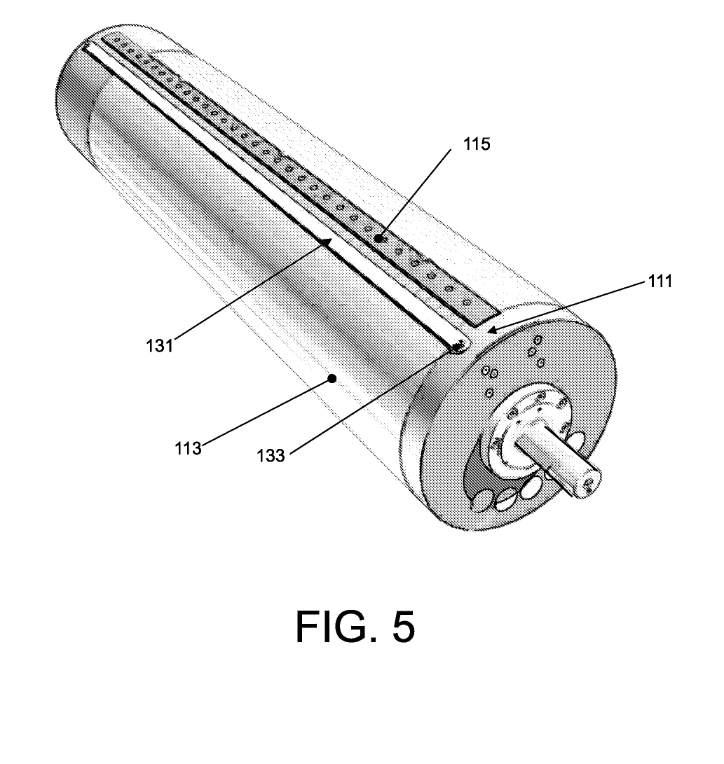

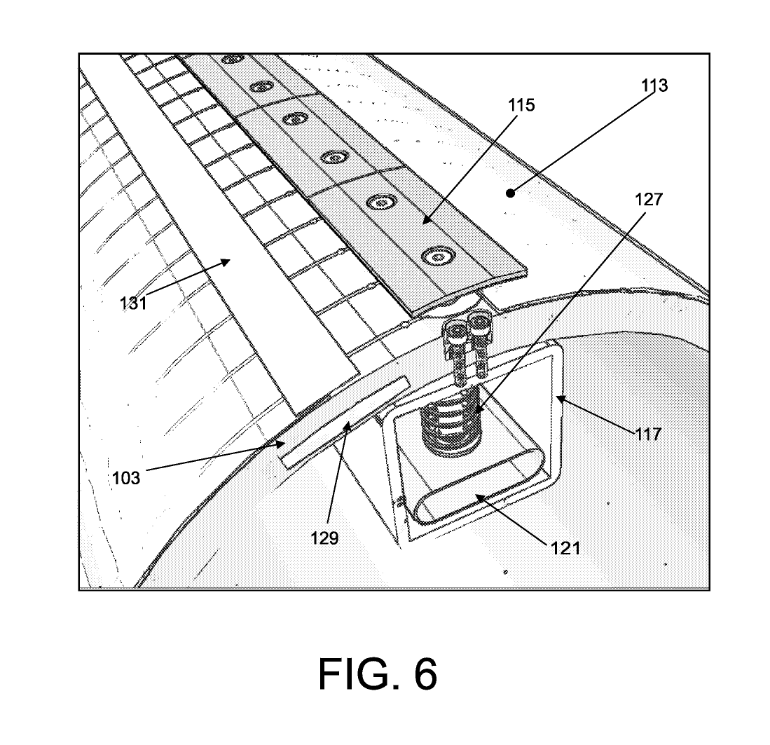

FIG. 5 shows a perspective view of an embodiment of the imaging cylinder 100 with the metal bar 131 and a plate thereon, according to an embodiment of the present invention. The clamping element is fragmented in this embodiment. That the clamping bar is fragmented is shown more clearly in FIG. 6, which shows a perspective view of a cutout of the imaging cylinder 100 including an embodiment of the present invention. As can be seen, the bar 115 includes a plurality of clamping segments in the axial direction to support clamping of more than one plate distributed in the axial direction.

To provide the metal bar 131 from slipping, it is fixed by two fixing elements 133 on each side of the imaging cylinder, as seen in FIG. 1A and FIG. 5. In one embodiment, the fixing elements 133 are bolts, and the imaging cylinder 100 has matching tapped holes made for the bolts to be afixed thereto.

FIG. 1A shows the metal bar and fixing elements 133 in the unfixed position, while FIG. 1C shows these fixed onto the cylinder 100.

While in one embodiment, the magnetized element 133 is on the surface of the imaging cylinder 100, it is known that surface differences on the surface 111 of an imaging cylinder might lead to patterns being exposed on the plate because of backreflection of energy arriving from energy pasing through the imaging cylinder and relacted back by the surface via the back of a plate during exposure. Therefore, as shown in FIG. 1A, one embodiment of the invention uses a multi-layer imaging cylinder, with an inner core 105. The magnetized element 129 is in the core between the outer and inner cylindrical surfaces 103 and 107, so hidden under the outer cylinder 103 of the imaging cylinder. The invetors have found that this reduces exposure problems from back-reflection due to surface differences.

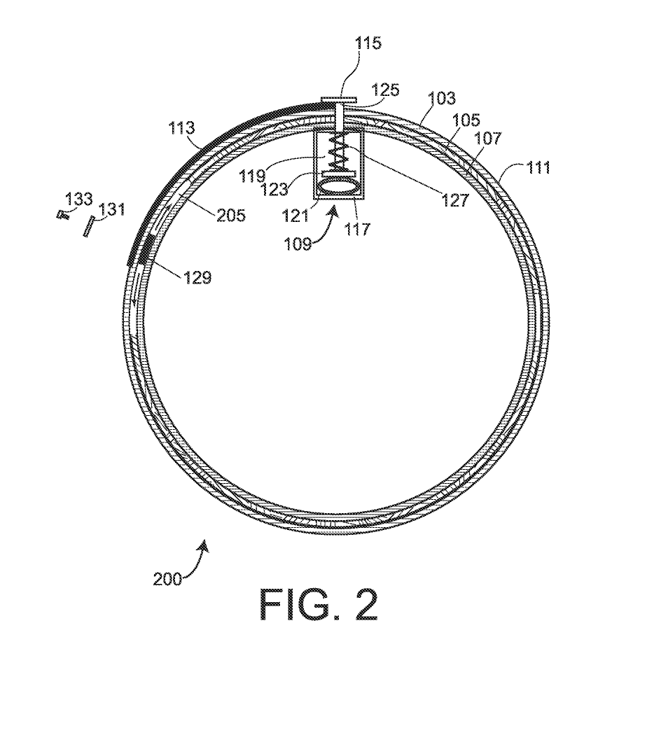

FIG. 2 shows an alternate embodiment 200 of the imaging cylinder in which the magnetized element 129 is made adjustable in the circumferential direction of a cross section perpendicular to the radial direction in a gap 205 between the outer layer 103 and inner layer 107 of the imaging cylinder. This allows one to fix plates of different extent. Note that the same reference numeral is used to describe the magnetized element 129, and those in the art will inderstand that a different shape element 129 might need to be used in the embodiment shown in FIG. 2.

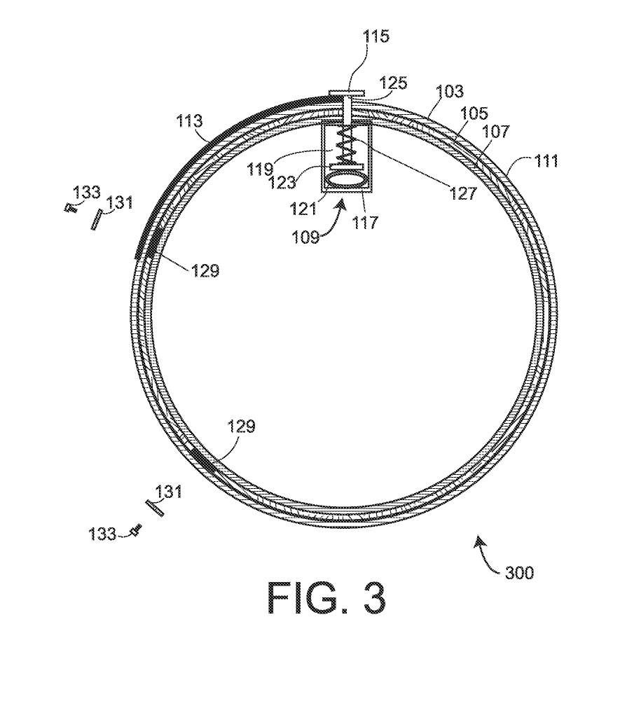

FIG. 3 shows another embodiment of an imaging clylinder 300 in which a plurality of magentic elements 129 are distributed along the circumferential direction between the outer layer 103 and the inner layer 107 of the imaging clylinder 300 so that plates of different lengths can be placed on the surface 111 of the imaging cylinder 300. As before, one end of the plate is clamped using the clamping device 109, and the other end is fixed onto the surface of the imaging clyinder using a metal bar 131.

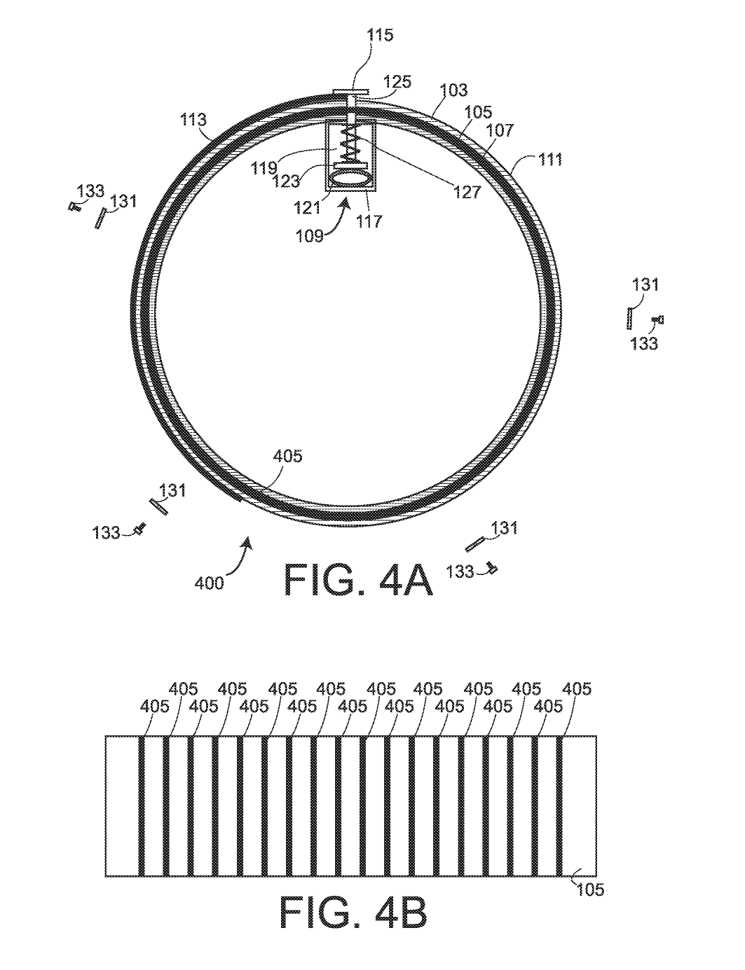

FIG. 4A shows a cross section of yet another embodiment of an imaging cylinder 400 in which the core layer 105 between the outer layer 103 and inner layer 107 of the cylinder has a plurality of magnetized elements 405 that extend the whole circumference of the the core layer 105.

FIG. 4B shows a view of the core layer 105, including the magnetized elements 405.

FIG. 4A shows a bluraly of metal bars 131 and fixing elements 133 at various circumferential locations so that plates of differnet sizes can be fixed.

Note that in the case that a metal back plate is used, a metal bar 131 need not be used.

One embodiment of the invention includes the imaging cylinder 100 operating automatically.

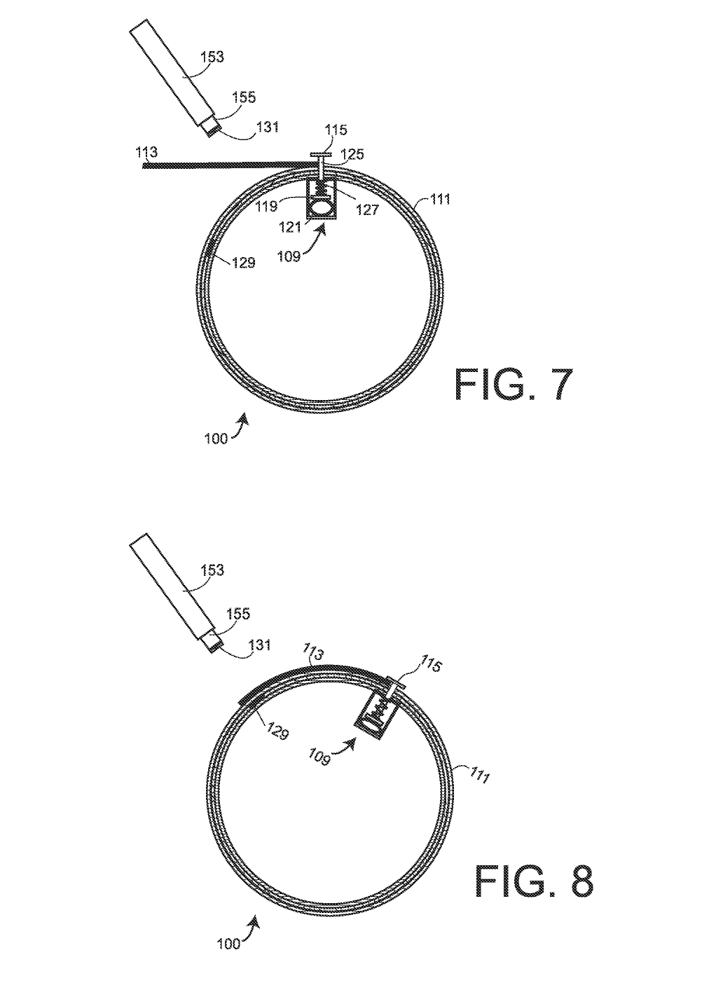

FIGS. 7 through 10 show different stages of operation of an automatic loader and unloader. Each of FIGS. 7 to 10 shows a clamping system that includes the imaging cylinder 100 as shown in FIG. 1A, and a handling unit that includes a body 153 and a telescopic extension arm 155 that is operative to selectively hold and feed the metal bar 131 onto the imaging cylinder 100. Not shown in FIGS. 7 to 10 are other elements of an automatic loader/unloader. Such elements are shown in FIG. 1C. The handling unit is coupled to the control system 147 and operates under guidance of the control system. Not shown is a motor 151 coupled to the control system 147 and operative to rotate the imaging cylinder. In one embodiment, under guidance of the control system, the motor 151 rotates the imaging cylinder so that the handling unit is aligned with the magnetized element 129.

Initially, the metal bar 131 is held by the metal bar handling unit 155, 153. FIG. 7 shows one end of a plate 113 fixed onto the surface 111 of the imaging cylinder 100 by the clamping element 115 using a clamping device 109 automatically operated.

After the first end of the plate is fixed onto the surface 111 by the clamping element 115, the cylinder with the plate 113 thereon rotates until the magnetized element 129 is aligned with the metal bar handling unit 155, 153 with the metal bar 131 thereon. As the cylinder rotates, the cylinder draws the plate onto the surface. FIG. 8 shows the system after the rotation.

At this stage, the telescopic extension arm 155 extends towards the surface 111 of the imaging cylinder 100 and feeds the steel bar 131 onto to the imaging cylinder 100's surface so that the steel bar 131 clamps the plate 113 onto the surface of the imaging cylinder 100. The second plate end is thus clamped onto the cylinder surface 111 by the magnetic force between the metal bar 131 and the magnetized element 129.

In one embodiment, the handling unit also is arranged to fix the two fixing elements onto the imaging cylinder 100 to prevent the metal bar 131 from slipping along the surface.

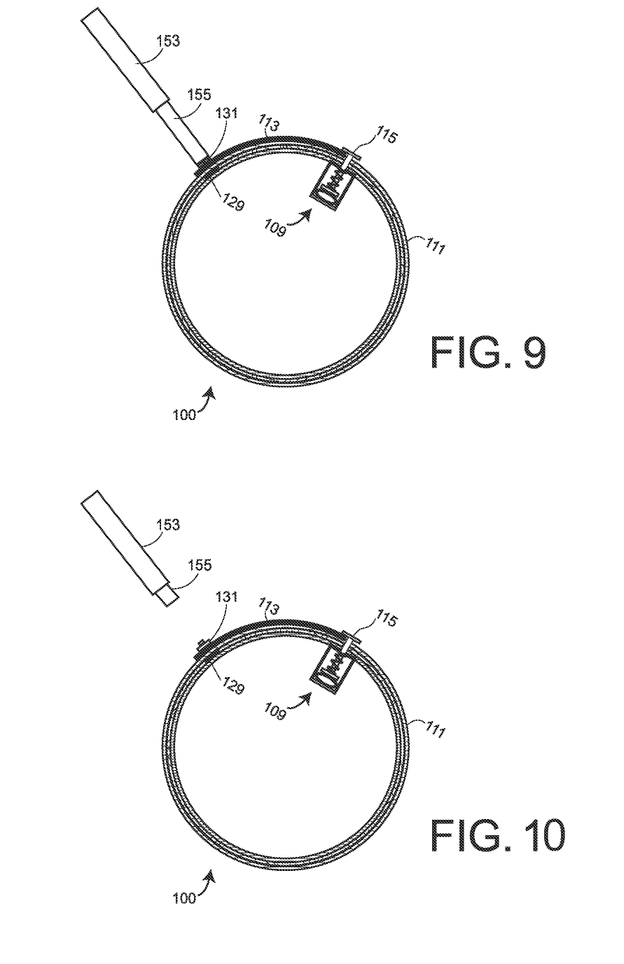

FIG. 9 shows the the telescopic extension arm 155 extended towards the surface 111 of the imaging cylinder 100 and feeds the steel bar 131 onto to the imaging cylinder 100's surface.

After the fixing elements 133 are mounted, the telescopic extension arm 155 retracts back to its home position in the body 155. FIG. 10 shows the system after the extension arm 155 is back in its start position. The plate 113 is fully mounted onto the surface 111 of the imaging cylinder, and ready for imaging.

Thus, an apparatus and a method have been described. One embodiment is operated manually, while another embodiment is operated automatically. The apparatus is to clamp all types of plates of a variety of thicknesses onto the surface of an imaging cylinder.

One embodiment avoids or reduces back-reflection exposure problems by including hidden magnet elements.

One embodiment includes register pins.

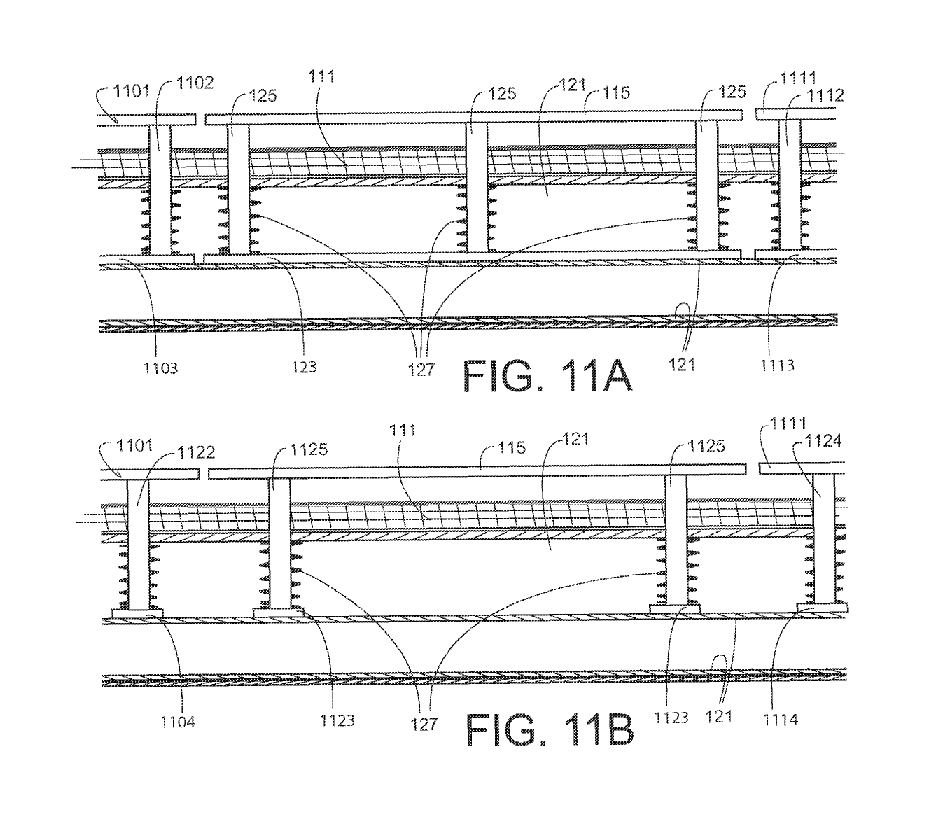

One embodiment includes a plurality of clamping elements such as 115 oriented along the axial direction such that the clamping of more than one flexible plate in the axial direction is possible. FIG. 11A shows the section A-A shown in FIG. 1A, but with the clamping device 109 in the open position and with a plurality of clamping elements, according to a first embodiment. In addition to the clamping element 115, part of two adjacent clamping elements 1101 and 1111 are shown. Each clamping element is attached to its own set of guiding shafts, three shafts 125 are shown for clamping element 115, and one guiding shaft 1102, 1112 of the respective sets of shafts attached to the clamping elements 1101 and 1111 are shown. The other ends of the guiding shafts are attached to respective lifting elements. Lifting element 123 is coupled to all shafts 125 and clamping element 115, while parts of lifting elements 1103 and 1113 are coupled via shafts 1102 and 1112, respectively, to the clamping elements 1101 and 1111, respectively. A first set of springs 127 is shown around shafts 125, a second set around shafts 1102, and a third set around shafts 1112.

FIG. 11B shows the section A-A shown in FIG. 1A, according to a different second embodiment. In this embodiment, each clamping element typically has more than one, e.g., two guiding shafts. Each guiding shaft has its own separate lifting element, rather than the lifting element shown attached to all guiding shafts of a clamping element as shown in FIG. 11A. Each lifting element of the same clamping element can move independently, whereas in the embodiment shown in FIG. 11A, the lifting elements of that are coupled by respective guiding shafts to the same clamping element are mechanically one, so move together. In FIG. 11B, two shafts 1125 are shown for clamping element 115, and one guiding shaft 1122, 1124 of the respective pairs of shafts attached to the clamping elements 1101 and 1111 are shown. Lifting elements 1123 are separately coupled to each shafts 1125 and clamping element 115, while lifting elements 1104 and 1114 are coupled via shafts 1122 and 1124, respectively, to the clamping elements 1101 and 1111, respectively. A first set of springs 127 is shown around shafts 1125, a second set around shafts 1122, and a third set around shafts 1124.

By arranging each clamping element to have its own guiding shafts, lifting elements, and springs, for example, as in either FIG. 11A or 11B, the different clamping elements can clamp plates of different thicknesses.

Note that in the embodiments shown, only one inflatable hose 121 is used for the whole axial length, i.e., for all the clamping elements. In an alternate embodiment, independent hoses are used such that individual clamping elements may be individually controlled by switchably supplying air pressure to respective hoses.

Thus, an alternate embodiment includes a plurality of instances of the clamping device, such clamping devices distributed along the axial direction of the cylinder, each clamping device adapted to clamp a plate independently of the clamping by the other clamping device(s).

In one embodiment, the cylinder has a circumference of approximately 129 cm and an axial length of 210 cm. Such a cylinder 100 can accommodate, for example, plates of 50 in by 80 in. In one embodiment, 20 clamping devices are distributed in the axial direction.

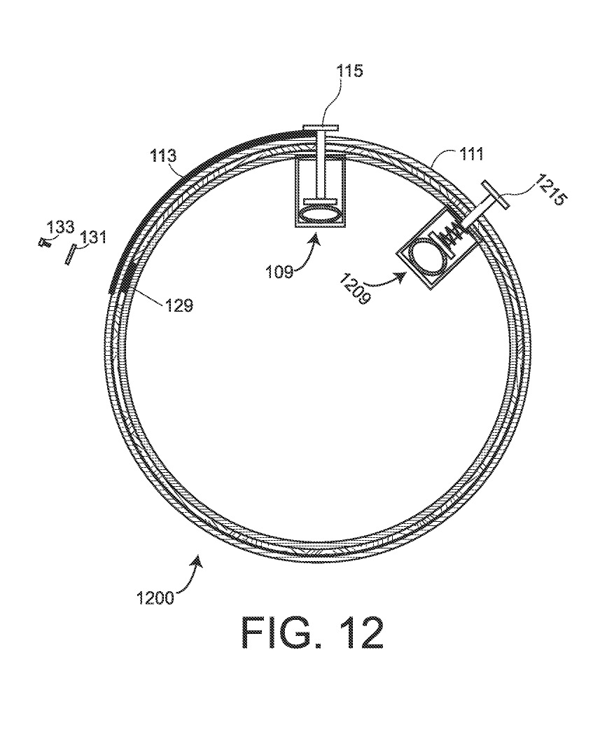

Another aspect of the invention is that a plurality of clamping devices are provided in the circumferential direction. FIG. 12 shows a cylinder 1200 with two instances of the clamping device: the clamping device 109, and additional clamping device 1209 that respectively includes clamping element 1215. The second clamping device is shown in the open (unclamping) position. Having a plurality of clamping devices in the circumferential direction provides for a plurality of plate segments that are shorter in the circumferential direction to be loaded.

One embodiment includes clamping elements distributed at two locations in the circumferential direction. In an alternate embodiment, three locations are used in the circumferential direction.

While apparatus embodiments are described above, another aspect of the invention is a method of loading a plate onto an imaging cylinder by using the apparatus as described herein.

Note that while in one embodiment, the inflatable air hose 121 is inflated with air, in alternate embodiments, another gas is used, and in yet another embodiment, a liquid is used.

Note that while the gap is shown being formed between the clamping element 115 and the outer surface 111 of the cylinder 100, the term outer surface 111 in this context includes the case that the outer surface 111 is somewhat indented in the area of the clamping element.

It should be appreciated that although the invention has been described in the context of flexography, the invention is not limited to such contexts and may be utilized in various other applications and systems for mounting one or more plates or plate segments onto an imaging cylinder.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or elements of a method forms a means for carrying out the method or element of a method. Furthermore, an element described herein of an apparatus embodiment is an example of a means for carrying out the function performed by the element for the purpose of carrying out the invention.

All publications, patents, and patent applications cited herein are hereby incorporated by reference.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. Thus, the scope of the expression a device A coupled to a device B should not be limited to devices or systems wherein an output of device A is directly connected to an input of device B. It means that there exists a path between an output of A and an input of B which may be a path including other devices or means.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

We claim:

1. An apparatus comprising:
an imaging cylinder of an imaging device, the cylinder having an outer surface and an inner wall;
a clamping device arranged for clamping one edge of a flexible plate onto the outer surface of the cylinder; and
at least one magnetized element close to or on the surface of the cylinder, such that a metal bar made of a material attracted to the magnetized element placed on a plate clamped at the one edge and close to a magnetized element maintains a force on the plate towards the surface of the cylinder,
wherein the clamping device includes:
a base body having a hollow interior, and extending in the axial direction of the cylinder, the base body being fixed to the inner wall of the cylinder or incorporated into the inner wall of the cylinder;
a clamping element having a width and extending in the axial direction of the cylinder, located adjacent to the outer surface of the cylinder wherein the base body is located;
a lifting element located in the interior of the base body and coupled to the clamping element by at least one guiding shaft, the lifting element being movable in a first radial direction to move the clamping element away from the outer surface of the cylinder to form a gap between the outer surface and the clamping element, the lifting element further being movable in the radial direction opposite the first radial direction to close the gap formed between the outer surface of the cylinder and the clamping element; and
a mechanism to impart and maintain compressive force between the clamping element and the outer surface of the cylinder such that any gap formed is maintained closed unless forcibly opened,
wherein the width of the clamping element is configured such that a gap formed between the clamping element and the outer surface is sufficient to grip the edge of a plate when the gap is closed,
such that when the gap is formed by moving the lifting element in the first radial direction, the edge of a flexible plate can be placed in the gap, and such that when the gap is closed, the plate is maintained clamped onto the outer edge of the cylinder.

2. An apparatus as recited in claim 1, wherein the metal bar is fixable to the cylinder by one or more fixing elements.

3. An apparatus as recited in claim 1, wherein the one or more magnetized elements are in an inner core of the cylinder between the outer surface and the inner wall.

4. An apparatus as recited in claim 3, wherein at least one of the one or more magnetized elements is movable in a circumferential direction so that the distance along the circumference between the clamping element and the movable magnetized element is adjustable to accommodate plates of different length.

5. An apparatus as recited in claim 3, wherein the one or more magnetized elements include one or more magnetized elements each approximately covering the whole circumference of the imaging cylinder, and distributed in the axial direction.

6. An apparatus as recited in claim 1, further comprising an inflatable hose arranged in the interior of the base body and adapted to move the clamping device in the first radial direction when pressure is applied to inflate the inflatable hose.

7. An apparatus as recited in claim 6, wherein the mechanism to impart and maintain compressive force includes at least one spring between the lifting element and the inner wall of the cylinder such that the spring is biased to impart and maintain the compressive force in the radial direction, and such that when the inflatable hose is inflated, a force opposite to the compressive force is applied on the lifting element to move the clamping element in the first radial direction away from the outer surface of the cylinder.

8. An apparatus as recited in claim 1, wherein the clamping device includes at least one further clamping element in the axial direction, such that a plurality of plates of different thickness are able to be placed distributed in the axial direction of the cylinder and clamped onto the outer surface of the cylinder.

9. An apparatus as recited in claim 1, further comprising at least one other instance of the clamping device, such clamping devices distributed along the circumferential direction of the cylinder, such that a plurality of plates of different formats may be clamped onto the outer surface of the cylinder.

10. An apparatus as recited in claim 1, further comprising at least one other instance of the clamping device, such clamping devices distributed along the axial direction of the cylinder, each clamping device adapted to clamp a plate independently of the clamping by the other clamping devices.

11. An apparatus as recited in claim 10 further including a plurality of the clamping devices distributed along the circumferential direction of the cylinder to clamp a plurality of plates of different formats and thickness on the peripheral surface of the cylinder.

12. An apparatus as recited in claim 1, further comprising at least one other instance of the clamping device, such other instances of the clamping devices distributed along the circumferential direction of the cylinder, such that a plurality of plates of different formats may be clamped onto the outer surface of the cylinder.

13. An apparatus as recited in claim 7, wherein the inflatable hose is coupled to a switchable supply of air pressure, such that switching the air pressure on or off opens or closes the gap.

14. An apparatus as recited in claim 13, further comprising:
a control system coupled to the switchable supply of air pressure and operative to cause the apparatus to automatically open or close the gap according to a sequence of loading or unloading;
a handling unit coupled to the control system and operative to selectively hold and feed the metal bar onto the imaging cylinder according to the imaging sequence; and
a motor coupled to the control system and operative to rotate the imaging cylinder so that the handling unit is aligned with a magnetized element.

15. An apparatus as recited in claim 14, wherein the handling unit includes a body and a telescopic extension arm operative in combination and under control of the control system to selectively hold and feed the metal bar.

16. An apparatus as recited in claim 13, wherein the switchable supply of air pressure includes a pump and a switch to switch the pump on or off.

17. An apparatus as recited in claim 13, wherein the switchable supply of air pressure includes a valve element to switch the supply of air pressure on or off.

18. A method comprising:
moving a clamping element having a width and extending in the axial direction of an imaging cylinder of an imaging device, the cylinder having an outer surface and an inner wall, the clamping element located adjacent to the outer surface of the cylinder, the moving being in a first radial direction away from the outer surface of the cylinder to form a gap between the outer surface and the clamping element, the clamping element having a width configured such that a gap formed between the clamping element and the outer surface is sufficient to grip the edge of a plate when the gap is closed;
placing a first edge of a flexible plate in the gap between the outer surface of the cylinder and the clamping element;
moving the clamping element in a radial direction opposite to the first radial direction to close the gap;
maintaining a compressive force onto the edge placed between the outer edge and the clamping element to hold the plate in a clamped state; and
placing a metal bar having a length in the axial direction and made of a material attracted to magnetized material on the plate close to the second end of the plate such that magnetic attraction between the metal bar and at least one magnetized element close to or on the surface of the cylinder maintains a force on the plate towards the surface of the cylinder.

19. A method as recited in claim 18, wherein the moving of the clamping element is by moving a lifting element located in the interior of a base body having a hollow interior and extending in the axial direction of the cylinder, the base body being fixed to the inner wall of the cylinder or incorporated into the inner wall of the cylinder, the lifting element being coupled to the clamping element by at least one guiding shaft.

20. A method as recited in claim 19, wherein the maintaining of the compressive force is by a set of at least one spring between the inner wall of the cylinder and the lifting element, the set of at least one spring being biased to impart a compressive force to close the gap between the clamping element and the outer surface of the cylinder.

21. A method as recited in claim 19, wherein the moving of the clamping element in the first and in the opposite direction is by respectively applying and removing pressure in an inflatable hose located in the interior of the base body and configured such that when the hose is inflated by applying pressure, the clamping element moves in the first radial direction away from the outer surface of the cylinder, and when the hose is deflated by removing the pressure, the clamping element moves in the radial direction opposite to the first radial direction, and the compressive force is applied.

22. A clamping means comprising:
means for moving a clamping element having a width and extending in the axial direction of an imaging cylinder of an imaging device, the cylinder having an outer surface and an inner wall, the clamping element located adjacent to the outer surface of the cylinder, the means for moving configured to move the clamping element in a first radial direction away from the outer surface of the cylinder to form a gap between the outer surface and the clamping element, such that the edge of a flexible plate may be placed in the gap between the outer surface of the cylinder and the clamping element;
means for moving the clamping element in a radial direction opposite to the first radial direction to close the gap;
means for maintaining a compressive force onto any edge of a plate placed between the outer edge and the clamping element to hold the plate in a clamped state; and
means for placing a metal bar having a length in the axial direction and made of a material attracted to magnetized material on the plate close to the second end of the plate such that magnetic attraction between the metal bar and at least one magnetized element close to or on the surface of the cylinder maintains a force on the plate towards the surface of the cylinder,
wherein the width of the clamping element is configured such that a gap formed between the clamping element and the outer surface is sufficient to grip the edge of a plate when the gap is closed.

23. A clamping means as recited in claim 22, wherein the means for moving of the clamping element includes means for moving a lifting element extending in the axial direction of the cylinder and coupled to the clamping element.

24. A clamping means as recited in claim 23, wherein the means for maintaining the compressive force uses a set of at least one spring between the inner wall of the cylinder and the lifting element, the set of at least one spring being biased to impart a compressive force to close the gap between the clamping element and the outer surface of the cylinder.

25. A clamping means as recited in claim 23, wherein the means for moving of the clamping element in the first and in the opposite directions is by respectively applying and removing pressure in an inflatable hose located and configured such that when the hose is inflated by applying pressure, the clamping element moves in the first radial direction away from the outer surface of the cylinder, and when the hose is deflated by removing the pressure, the clamping element moves in the radial direction opposite to the first radial direction, and the compressive force is applied.
